(19) United States
(12) Patent Application Publication
(10) Pub. No.: US 2013/0200009 A1
(43) Pub. Date: Aug. 8, 2013

(54) Method for Synthesis of MultiFunctional FE6+ - FE3+ Agent

(71) Applicant: Maohong Fan, Ames, IA (US)

(72) Inventor: Maohong Fan, Ames, IA (US)

(73) Assignee: THE UNIVERSITY OF WYOMING, Laramie, WY (US)

(21) Appl. No.: 13/537,780

(22) Filed: Jun. 29, 2012

Related U.S. Application Data
(60) Provisional application No. 61/505,686, filed on Jul. 8, 2011.

(51) Int. Cl. C02F 1/72; C01D 1/02

(52) U.S. Cl. CPC C02F 1/72; C01D 1/02
USPC 210/758; 423/594.2

(57) ABSTRACT

The present invention is a new, easy method for preparing stable solid Fe⁶⁺—Fe³⁺ agents in a fixed bed reactor by using O₃ and FeOOH along with KOH with conversion efficiencies of approximately 27%. In addition, the product has been used to oxidize oil from water and to destroy tetracycline in water

This application claims priority to U.S. Patent Application Ser. No. 61/505,686, filed Jul. 8, 2011, which is incorporated herein by this reference in its entirety.

### BACKGROUND OF THE INVENTION

The present invention relates generally to the preparation of ferrate and, more specifically, to an easy and efficient method of preparing stable solid Fe⁶⁺—Fe³⁺ agent in a fixed bed reactor by using ozone (O₃) and Fe(III) oxide-hydroxide (FeOOH) along with an alkali metal hydroxide such as potassium hydroxide (KOH).

The problems of water pollution continue to be of concern and as a consequence the regulated standards for drinking water supply and wastewater discharge are becoming more stringent. Hence there is a continuing interest in the application of new effective oxidizing agents (or called disinfection agents in during water treatment industry) to improve water quality.

Chlorination is the most common oxidation/disinfection technology for drinking water treatment. However, there are some limitations of chlorination due to the formation of potential harmful disinfectant/disinfection by-products (DBPs). Although great efforts have been made to minimize the concentration of DBP by removing natural and synthetic organic compounds prior to disinfection, or removing the DBP after disinfection, this greatly increase the overall cost of water treatment. Alternative oxidants (e.g., chlorine dioxide, monochloroamine, ozone and KMnO₄) have been thus considered to replace the chlorine. However, treatment success using these disinfectants depends on the source water conditions such as pH, and the existing levels of bromide, iodide and natural organic matter (NOM). For example, ozone can reduce levels of THMs and halo acetic acids (HAAs), but it can form the potent carcinogenic bromate ion by reacting with bromide present in water (Gunten 2003; Richardson 2003). Recent research suggests that treatment with monochloroamine produces N-nitrosodimethylamine (NDMA), a suspected human carcinogen (Mitch & Sedlak 2002).

Potassium permanganate (KMnO₄) is another commonly used oxidant, which has been used as a disinfectant for water, i.e., removal of iron, bad taste and bad smell from waste water and wells. In the KMnO₄, the Mn is in the oxidation state +7 and most of its applications are centered on its very high oxidation power. This is also one of the causes of its negative effects. In fact, potassium permanganate will have tendency to oxidize organic or inorganic materials present into water, and that reduces the disinfection effectiveness. In the pH range of 4 to 9, an important number of organic and inorganic compounds will be oxidized. Under that condition iron is oxidized and precipitated (Hazen and Sawyer, 1992). It has been proved that the disinfection effectiveness will be lower in alkaline conditions (Cleasby et al., 1964 and Wagner, 1951). So, to enhance disinfection, the used of acid is often needed. It is suggested to combine both chlorine and permanganate for water treatment to reduce DBP. The last will be use for pre-treatment and the first one will be use for post-treatment. Another big preoccupation is the fact that KMnO₄ is irritating to skin, can injure, and is toxic and can kill if swallowed (EPA Guidance Manual, 1999).

Fe(VI) in the form of potassium ferrate (K₂FeO₄) has been found to be a powerful oxidant over a wide pH range and many studies have considered its role as an oxidant in water and wastewater treatment (Jiang and Lloyd, 2002). Under acidic conditions, the redox potential of ferrate (VI) ions is the strongest among all oxidants/disinfectants (E⁰=+2.20 V) used for degradation of various organic matter and microorganisms. The reduction potentials of ferrate in acidic and alkaline solutions can be seen in the reactions (1) and (2) (Wood, 1958).

FeO₄²⁻+8H⁺+3e⁻→Fe³⁺+4H₂O,E⁰=+2.20V (1)

FeO₄²⁻+4H₂O+3e⁻→Fe(OH)₃+5OH⁻,E⁰=+0.72V (2)

Even under neutral conditions (Eq. (2)), the redox potential of ferrate (VI) (E⁰=+0.72V) is still greater than that of permanganate (MnO₄⁻) which is a strong oxidant. Therefore, very low doses of ferrate (VI) can perform superior degradation on various organic matter and microorganisms. Ferrate (VI) is also a coagulant, during the oxidation/disinfection process, where ferrate (VI) ions are reduced to Fe(III) ions or ferric hydroxide, which simultaneously generates a coagulant in a single dosing and mixing unit process.

The ferrate (VI) species were discovered a century ago, and the renaissance of interest in ferrate (VI) application began in the 1970s. The superior performance of ferrate (VI) as an oxidant/disinfectant and coagulant was demonstrated by several researchers (e.g., Jiang et al., 2001; Fan et al., 2002; Ma and Liu, 2002a,b; Jiang, 2003; Jiang and Wang, 2003; Qu et al., 2003; Sharma, 2004; Jiang et al., 2005, 2006a,b; Sharma and Mishra, 2006; Jiang et al., 2007). Therefore, it is important to explore the application of ferrate (VI) for water and wastewater treatment practice, and for environmental remediation (Jiang, 2007). Extensive studies on ferrate (VI) are also due to its unique oxidation/coagulation capacity in the environmental remediation and it is a “green” chemical.

A number of researchers have been carried out for the degradation of various pollutants. The oxidation by ferrate (VI) of organic contaminants such as phenol and chlorophenols (Graham et al., 2004), organic nitrogen compounds (Sharma, 2010), alcohol (Williams et al. 1974), amino acids (Rush and Bielski, 1995), have been investigated. In addition, the emerging micro-pollutants such as endocrine disrupt chemical (EDCs) (Li and Li, 2007), pharmaceuticals (Virender et al., 2006) and arsenic (Fan et al., 2002), have been shown to be readily oxidized by ferrate (VI). The ferrate has also been proven to be used in organic synthesis, oxidizing primary and secondary alcohols to aldehydes (Wiley, 2001). The percentage oxidation of these pollutants strongly depends on the dose of ferrate (VI), and overdoses of ferrate (VI) were proved to be most effective in reducing pollutants.

Ferrate (VI) is also a coagulant, during the oxidation/disinfection process, where ferrate (VI) ions are reduced to Fe (III) ions or ferric hydroxide, which simultaneously generates a coagulant in a single dosing and mixing unit process. Also, Ghosh, Stuart and Wang (1999) built and tested ferrate cathodes for a new class of rechargeable electric battery. Those batteries appeared to have a capacity almost 50% higher than the conventional manganese dioxide batteries of the same size and produce rust less toxic than the rust from the manganese dioxide batteries. Potassium ferrate has been also being found effective in wound treatment. (Hen, Thompson, Keene, Tollon, Travi, US Patent Application Publication No. 2009/0252799) claimed the composition of a product with salt ferrate that can be used to stop wound hemorrhaging. However, ferrate (VI) technology has so far not yet been implemented to water and wastewater treatment practice, largely because ferrate (VI) solutions are generally unstable.

Ferrate (VI) decomposition occurs rapidly at room temperature and depends strongly on the initial ferrate (VI) concentration, co-existing ions, pH, and temperature of the solution (Schreyer and Ockerman, 1950). The known preparation methods for ferrate (VI) are all based on the liquid based process. They are the wet chemical method, electrochemical thermal synthesis and thermal synthesis.

In general, ferrate (VI) can be prepared by wet chemical and thermal synthesis and electrochemical synthesis. These three methods are all based on liquid ferrate. In the wet method, a Fe (III) salt is oxidized under strong alkaline conditions and either hypochlorite or chlorine is used as an oxidant. In the electrochemical method, anodic oxidation uses iron or alloy as the anode and NaOH/KOH as the electrolyte. In the thermal chemical synthesis method, various iron oxide-containing minerals are heated or melted under strong alkaline conditions and with oxygen flow. This method proves to be quite dangerous and difficult, since the synthesis process could cause detonation at elevated temperatures. The first approach is widely considered to be the most practical. The principle and the process for above methods are reviewed as following:

Wet synthesis: In 1951, Thompson et al. described the preparation of potassium ferrate by the wet method. This method produces sodium ferrate (VI) (Na₂FeO₄) from the reaction of ferric chloride with sodium hypochlorite in the presence of sodium hydroxide (Thompson et al. 1951; Schreyer et al. 1953; White & Franklin 1998). Potassium hydroxide is added to a sodium ferrate (VI) solution to precipitate potassium ferrate (VI) (K2FeO4). The basic reactions are as follows:

2FeCl₃+3NaOCl+10NaOH→2Na₂FeO₄+9NaCl+5H₂O (3)

Na₂FeO₄+2KOH→K₂FeO₄+2NaOH (4)

This procedure produces a 10-15% yield of potassium ferrate (VI) and many separation steps are required to obtain solid potassium ferrate (VI) of more than 90% purity.

Electrochemical method: The electrochemical preparation of ferrate usually consists of a sacrificial anode in an electrolysis cell containing a strongly alkaline solution such as NaOH or KOH with an electric current serving to oxidize the iron to Fe (VI). The basic principle of production is shown in Eqs. (5)-(8) (Bouzek and Rousar, 1993; Licht et al., 2001; Labique and Valentin, 2002; Licht et al., 2002; Jiang and Lloyd, 2002).

Anode reaction: Fe+8OH⁻→FeO₄²⁻+4H₂O+6e (5)

Cathode reaction: 3H₂O→3H₂+6OH⁻-6e (6)

Overall reaction: Fe+2OH⁻→FeO₄²⁻+3H₂+H₂O (7)

FeO₄²⁻+3K⁺→K₂FeO₄ (8)

In recent years, electrochemical synthesis has received the most attention due to its ease and the high purity of the product. The production yield is revealed to be strongly dependent on the electrolyte temperature and current density. Some researchers have focus on the on-line production and application of ferrate using electrochemical method.

Thermal chemical synthesis method: Thermal chemical synthesis was attempted for the first time by heating iron or iron oxide (Fe₂O₃ or Fe₃O₄), to a range of 500-650° C., with an alkali metal oxide, peroxide, or nitrate salt [9,112-114]. Similarly, Fe³⁺ salts can be oxidized to ferrate (VI) in molten KOH in ambient atmosphere. The oxidation was carried out by first producing K₂O₂ from the reaction of KOH with atmospheric oxygen:

4KOH+O₂→2K₂O₂+2H₂O (9)

A similar reaction does not occur or is inefficient in molten NaOH, and it was found that Na₂O₂ must be employed directly in order to form ferrate (VI) [91,115].

Ferrate (VI) technology has so far not yet been implemented to water and wastewater treatment practice. This is because ferrate (VI) solutions are generally unstable and their decomposition occurs rapidly at room temperature. The solid ferrate (VI) salts are stable but costly as they require multiple chemical processes and long time synthesis. Solid potassium ferrate (VI) could be produced by adding potassium hydroxide into sodium ferrate (VI) solution to precipitate potassium ferrate (VI) (K₂FeO₄) (Schoch, Jr. et al, 1997). However, this procedure produces a 10-15% yield of potassium ferrate (VI) and many separation steps are required to obtain solid potassium ferrate (VI) of more than 90% purity. As a consequence, the wide use of ferrate (VI) by the industry is still limited. Preparing a solid ferrate using a simple method is a challenging project.

The instability of ferrate (VI) solution has been well reviewed [13]. The decomposition rate of ferrate (VI) depends strongly on the initial ferrate (VI) concentration, co-existing ions, pH, and temperature of the solution. As a consequence, the wide use of ferrate (VI) by the industry is still limited. To overcome the instability and high cost of using ferrate (VI), an ideal approach is to generate solid ferrate (VI) by one step.

One application of the solid ferrate (VI) is in the oxidation of petroleum in water, particularly petroleum that may entered water from an accidental crude oil spill or release. The response to an oil spill in water depends on the type of the oil, the location, how fast the cleanup team reaches the location, currents, wave action, the weather and other conditions. Initially, a millimeter-thick layer of crude oil floats on the water and over time it thins and spreads out. If the oil reaches shoreline, biodegradation is the most employed solution. The crews will pour biological agents first and then fertilizers such as nitrogen and phosphorus on the spill to foster the growth of bacteria and microorganisms. These last two will break down oil into less harmful fatty acids and CO₂. The disadvantages of this method are that it takes a lot of time and it is often appropriate for soil only and not effective for many types of oil (Andelin et, al, 1991). If the situation is such that the oil is offshore and there is no possibility of polluting coastal regions or marine life, the oil can be left alone and will break down naturally (dispersion and evaporation) thanks to a combination of sun, current, wind and wave action. Light oils will break down faster than heavy ones. If the oil spilled is still offshore and can potentially pollute or harm marine life, then the crews have few options. They may try to contain and skim the spill using buoyant booms to keep the oil from spreading out and the skimmer boat to suck or scoop the slick contained. Large sponges may also be used to absorb the slick. This method is not effective in high water or windy zone. In situ burning are sometime used but causes urge amount of toxic smokes and affects marine and coastal life and settlements. One of the most used solutions is oil dispersion. Some chemicals are used to reduce the surface tension between oil and water and promote the dilution of oil into water. The formation of oil droplets increases the oil surface area, thus increases surface contact and fastens the natural biodegradation of the oil. The problem is that this solution cause more problem than it solves (“Oil spill clean-up agents threaten coral reefs.” Science Daily. Jul. 31, 2007. http://www.sciencedaily.com/releases/2007/07/070,730172426.htm). In fact the oil plume, chemical and the mixture of both affect marine animals, sea grass, deep-water corals and human being by intoxication and poisoning. Also, the decision of using dispersant take in count the type of oil, the time since the spill, the environment involved and the weather.

To overcome the dangers, instability and high cost of using dispersants, boom and skimmer, sponge sorbents, in situ burning and natural break down, the oxidation of hydrocarbons by Fe⁶⁺—Fe³⁺ powder agent has been proven for the first time. This chemical compound will many times be safer, cleaner, cheaper, and more effective than the prior art systems. The usefulness or Iron VI has been proved in many areas. A new class of rechargeable electric battery with ferrate cathodes has been built and tested (Ghosh, Stuart and Wang (1999). United States Patent Application Publication No. 2009/0252799 describes the composition of a product with salt ferrate that can be used to stop wound hemorrhaging. The greatest usefulness of ferrate so far seems to be in the area of water treatment.

In fact, Fe(VI) in the form of potassium ferrate (K₂FeO₄) has been found to be a powerful oxidant over a wide pH range and many studies have considered its role as an oxidant in water and wastewater treatment (Jiang and Lloyd, 2002). Ferrate (VI) is also a coagulant, during the oxidation/disinfection process, where ferrate (VI) ions are reduced to Fe (III) ions or ferric hydroxide, which simultaneously generates a coagulant in a single dosing and mixing unit process. A number of researchers have been carried out for the degradation of various pollutants. The oxidation by ferrate (VI) of organic contaminants such as phenol and chlorophenols (Graham et al., 2004), organic nitrogen compounds (Sharma, 2010), alcohol (Williams et al. 1974), amino acids (Rush and Bielski, 1995), have been investigated. In addition, the emerging micro-pollutants such as endocrine disrupt chemical (EDCs) (Li and Li, 2007), pharmaceuticals (Virender et al., 2006) and arsenic (Fan et al., 2002), have been shown to be readily oxidized by ferrate (VI). The percentage oxidation of these pollutants strongly depends on the dose of ferrate (VI), and overdoses of ferrate (VI) were proved to be most effective in reducing pollutants. The ferrate has also been proven to be used in organic synthesis, oxidizing primary and secondary alcohols to aldehydes (Wiley, 2001).

### SUMMARY OF THE INVENTION

The present invention consists of a single step method to generate solid ferrate (VI). This method is safe, clean and produces solid potassium ferrate which is relatively stable. Here, FeOOH and KOH are used as the reactants and do not pose any significant health harm. KOH is first adsorbed on the surface and the pores of FeOOH, then ozone is used as an oxidant to transfer Fe(III) to Fe(VI) based on the solid process. The reaction parameters for high Fe(VI) conversion are presented. The solid ferrate (VI) is a surprisingly effective agent in degrading hydrocarbon pollutants in water.

### BRIEF DESCRIPTION OF THE DRAWINGS

FIG. 1 is a schematic diagram of the ferrate (VI) preparation process.

FIG. 2 is a chart of the standard curve of Fe (III) analysis.

FIG. 3 is a chart of the ferrate conversion vs. KOH/FeOOH ratio with a drying temperature of 70° C., a drying duration of 2 hours, a reaction temperature of 30° C., a reaction duration of 40 minutes and a mass flow rate of ozone of 21.41 g/h.

FIG. 4 is a chart of the ferrate conversion vs. KOH concentration with KOH/FeOOH of 0.65, a drying temperature of 70° C., a drying duration of 2 hours, a reaction temperature of 30° C., a reaction duration of 40 minutes and a mass flow rate of ozone of 21.41 g/h.

FIG. 5 is a chart of the ferrate conversion vs. FeOOH size with KOH/FeOOH of 0.65, a KOH solution concentration of 2.6 mol/L, a drying temperature of 70° C., a drying duration of 2 hours, a reaction temperature of 30° C., a reaction duration of 40 minutes and a mass flow rate of ozone of 21.41 g/h.

FIG. 6 is a chart of the ferrate conversion vs. sample drying temperature with FeOOH particle size <0.0097 inch, a KOH/FeOOH of 0.65, a KOH solution concentration of 2.6 mol/L, a drying duration of 2 hours, a reaction temperature of 30° C., a reaction duration of 40 minutes and a mass flow rate of ozone of 21.41 g/h.

FIG. 7 is a chart of ferrate conversion vs. sample drying duration with FeOOH particle size <0.0097 inch, KOH/FeOOH=0.65, KOH solution concentration of 2.6 mol/L, drying temperature of 88.2° C., reaction temperature of 30° C., reaction duration of 40 minutes and mass flow rate of ozone of 21.41 g/h.

FIG. 8 is a chart of ferrate conversion vs. sample relative humidity with FeOOH particle size <0.0097 inch, KOH/FeOOH=0.65, a KOH solution concentration of 2.6 mol/L, a drying temperature of 88.2° C., a drying duration of 2 hours, a reaction temperature of 30° C., a reaction duration of 40 minutes and a mass flow rate of ozone of 21.41 g/h.

FIG. 9 is a chart of ferrate conversion vs. reaction duration with FeOOH particle size <0.0097 inch, KOH/FeOOH=0.65, a KOH solution concentration of 2.6 mol/L, a drying temperature of 88.2° C., a drying duration of 2 hours, a reaction temperature of 30° C., a mass flow rate of ozone of 21.41 g/h.

FIG. 10 is a chart of ferrate conversion vs. reaction temperature with FeOOH particle size <0.0097 inch, KOH/FeOOH=0.65, a KOH solution concentration of 2.6 mol/L, a drying temperature of 88.2° C., a drying duration of 2 hours, a reaction duration of 120 minutes, a mass flow rate of ozone of 21.41 g/h.

FIG. 11a is a chart of the weight of ozone consumed as function of conversion of Fe(III) to iron Fe(VI), and FIG. 11b is a chart of the weight of ozone consumed as function of weight of iron VI produced (with FeOOH particle size <0.24638 mm, KOH/FeOOH=0.65, a KOH solution concentration of 2.6 mol/L, a drying temperature of 88.2 C, a drying duration of 2 hours, a reaction temperature of 40° C., a reaction duration of 120 minutes, a mass flow rate of gas of 2.26 L/min, a ozone concentration of 4.4 W %).

FIG. 12 is a chart of total organic carbon oxidized as function of Iron VI weight added for each sample.

FIG. 13 is a chart of the percentage of TOC oxidized as function of Iron VI weight added to each sample.

FIG. 14 is a chart of the measured TOC in the samples after oxidation vs. initial water pH.

FIG. 15 is a chart of the measured TOC in the samples vs. sample pH after oxidation.

FIG. 16 is a chart of the LR/MRM analysis results of the oxidation of tetracycline.

### DETAILED DESCRIPTION OF PREFERRED EMBODIMENTS

### Example 1

### Materials and Methods

### Chemicals

All the reagents used were of commercial origin. FeOOH from Kemira Water Solutions, Inc. was of purity >80% and the Fe (III) content is about 42%. KOH, HCl and HNO₃ were purchased from BDH. NH₄Fe (SO₄)₂.12H₂O was purchased from Alfa Aesar; H₂SO₄ and KMnO₄ were purchased from Fisher; KSCN was purchased from Lancaster Synthesis, Inc. Na₂B₄O₇.10H₂O (purity around 99%) and Na₂HPO₄ (reagent grade) which used for buffer solution and were purchased from Sigma Chemical Company. Ozone was produced from ultra high purity oxygen by an ozone generator from Pacific Ozone Technology of model L21.

### Ferrate (VI) Preparation

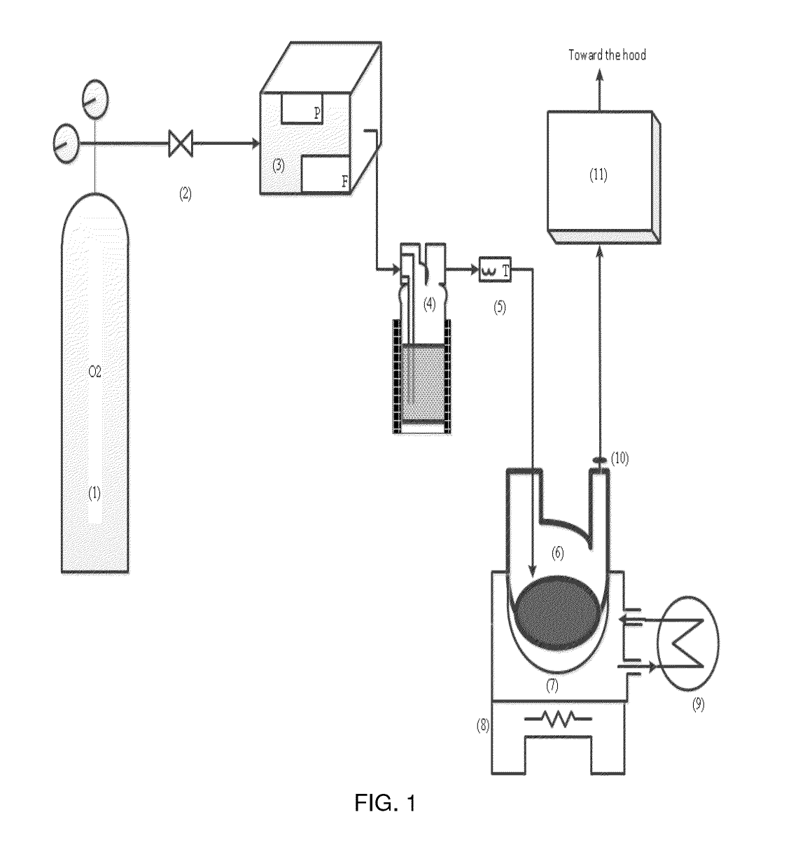

The setup for ferrate (VI) preparation is shown in FIG. 1, wherein oxygen is supplied from an oxygen cylinder 1 through a valve 2 to an ozone generator 3. The ozone is humidified in a humidifier 4 containing distilled water and carrying heat tape. A set of thermometers 5 is provided for measuring both wet and dry temperatures. The ozone is fed into a fixed bed reactor 6 containing FeOOH+KOH particles to be oxidized. The reactor 6 includes a jacket heat exchanger 7, a magnetic stir machine 8, a temperature controller for the heat exchanger 9, and a particle filter 10. An ozone analyzer 11 is used to analyze the effluent from the reactor 6.

The reaction is:

2FeOOH+4KOH+3O₃→2K₂FeO₄+3H₂O+3O₂ (10)

The preparation consists of two main steps which are the adsorption of KOH on the surface and the pores of FeOOH; and the oxidation of the obtained complex using ozone to obtain potassium ferrate.

First, a quantity of FeOOH is measured and introduced into a KOH solution in a glass container. The mixture is then slightly heated (about 60° C.) and stirred at the same time for about one minute. Afterward, it is placed in an oven in order to evaporate the water. The scale used throughout the experiment was a Sartorius Basic instrument. The oven was from Precision Scientific, of category 1250 and temperature range of 35° C. to 180° C. The thermocouple was an Omega type K. Once the complex (FeOOH+KOH) is dried, it is introduced in a fixed bed reactor for oxidation.

The oxidation process from Fe (III) to Fe (VI) is as follows: Ozone is produced from oxygen by a generator 3. That ozone produced is then humidified into a humidifier 4 containing just distilled water. After that, the humidified ozone enters the fixed bed reactor 6 for the oxidation of the complex (FeOOH+KOH). Glass fiber is pre introduced at the gas outlet of the reactor 6 to maintain the maximum of pressurized particles in the reactor 6. At the end of the reaction, a dark purple powder is obtained containing a significant proportion of potassium ferrate as well as unreacted reactant.

A challenge was to maximize the conversion of FeOOH into K₂FeO₄. The unreacted ozone (if any) and oxygen formed from the reaction exit the fixed bed reactor 6 to the hood (not shown). To control the reaction temperature, a water based temperature regulator (Fisher Scientific, model Iso temp 3006S) was used. The reaction temperature is measured by a thermocouple Omega of type K. The humidifier 4 is a 500 mL ChemGlass instrument, the flow meter used to control the outflow gas from the generator was a model FM-1050 from Matheson Tri.Gas. The ozone concentration was monitored by weight in a volume of gas produced over time and the ozone produced by the machine could be varied from 0% to 100% of the certified maximum ozone production.

It was important to know the flows in and out of the ozone in the system, both from a material balance and an environmental point of view. To this end, the mixed ozone-oxygen gas flows through a commercial process ozone sensor 11, which was a Model 452 (Teledyne Instrument). The ozone sensor 11 measures the absorption of UV at 254 nm. From (Langlais, et al., 1991; Duget, et al., 1986; Maurersberger, et al., 1986; Molina, 1986; Zurer, 1987) it is known that gas-phase ozone has an absorption coefficient of about 3000 L/mol/cm at 237 K and 101.3 KPa. The sensor 11 displays ozone concentration in the flow stream in % by weight or grams/Normal cubic meter.

### Analysis Methods

### Fe(III) Analysis Method

In order to analyze the Fe content in FeOOH, Fe(III), an analysis method was established using the reaction of Fe(III) with SCN⁻ to produce the complex FeSCN²⁺ which has a special absorbance at 447 nm.

An ammonium iron (III) sulfate solution is prepared by dissolving 0.8634 g NH₄Fe(SO₄)₂.12H₂O into 50 ml DI water, to which is added 20 ml 98% H₂SO₄ and/or 0.2 mol/L KMnO₄ solution drop by drop until the solution is slightly red. Transfer this solution into a 1000 ml volumetric flask and dilute to the mark, at which point the Fe(III) concentration solution is 100 mg/L. A potassium thiocyanate (KSCN) solution is prepared by dissolving 50 g KSCN into 50 ml DI water. A solution of HNO₃ is prepared by slowly adding 191 ml (1.42 g/cm³) HNO₃ into 200 ml DI water, and then diluting it to 500 ml in a volumetric flask. Six colorimetric tubes are prepared by adding 0.1 ml, 0.2 ml, 0.5 ml, 1.0 ml, 2.0 ml, and 4.0 mL of the ammonium iron (III) sulfate standard solution, respectively. DI water is added to about 40 ml, then 5 ml HNO₃ and 2 drops of KMnO₄ are added and the solutions are dilute to 50 mL using additional DI. Then 1 ml potassium thiocyanate solution is added. Shake the colorimetric tubes and let stand for about 20 minutes before measuring the absorbance. To the 40 ml sample, 5 ml HNO₃ is added and diluted to 50 ml suing DI water followed by the addition of 1 ml potassium thiocyanate solution. Shake the colorimetric tubes and let stand for about 20 minutes before measuring the absorbance. Thereafter, the Fe(III) concentration is calculated.

### Ferrate (VI) Analysis

At the end of the reaction, the obtained solid product was taken to a filter, the iron (VI) was then washed with a large quantity of buffer solution of pH about 9 and its concentration in that filtrate was finally determined by UV/vis spectrophotometer. The buffer solution of pH 9 was made by mixing 500 ml of 0.002 mol/L Na₂B₄O₇.10H₂O and Na₂HPO₄ solutions. The ferrate concentration was measured by means of UV-visible light absorbance spectroscopy at 510 nm. The molar absorbtivity at 510 nm has been determined previously as 1150 M⁻¹ cm⁻¹ by Bielski and Thomas (1987) which was based on the Beer-Lambert law.

Having the molar absorbtivity of the ferrate, an immediate measure of the filtrate at the spectrophotometer will give the absorbance of the light by the Iron VI and the concentration of Ferrate (VI) in the filtrate can be calculated according to the following formula:

$$conversion = \frac{( \frac{Abs}{1150 \times l} ) \times 56 \times Vol ( filtrate )}{Iron ( content ) \times FeOOH ( weight )} \qquad ( 12 )$$

where Vol (filtrate) is the volume of buffer solution used for the filtration, expressed in L. Iron (content) is the proportion of iron contained into the FeOOH. FeOOH, (weight) is the weight of FeOOH used for the reaction expressed in g, and 1 is 1 cm, the path length of the cuvette used in the spectrophotometer.

To make sure that no solid particles of Fe(III) cross the filter, two cellulose papers (from Whatman) of grade 1:11 μm were inserted in the filter and their efficacy was tested and confirmed. If some Fe(III) crossed the filter paper it would have reacted with the PO 4 contained in the buffer solution. It was verified that any other species present in the solution would not have any significant absorption at 510 nm to confirm that they do not interfere at that wavelength. To determine the best conditions for highest conversion, a titration method was used to evaluate the total iron in the filtrate to verify the conversion results at the selected conditions.

### Spectrometry Analysis of the Fe(III) of the Filtrate

After a certain time, the Fe(VI) present into the filtrate is reduced into Fe(III) and it was observed that after 5 hours, the color of the filtrate turned completely from purple into yellow, a sign that all the reduction reaction is completed and the Fe(III) contained in the filtrate can be analyzed. The spectrophotometer was calibrated and it was determined that the highest absorption was at of 477 nm. The Fe(III) content of a quantity FeOOH was tested and determined to be approximately 40%. Six hours after the filtration, 40 ml of filtrate is added into 40 ml of concentrated HCl and the solution is heated to dissolve the particles, if any. When the particles are dissolved, the solution is allowed to cool. The cooled solution is transferred into a 100 ml volumetric flask and diluted to the mark. Two ml of that diluted solution is poured into a colorimetric tube. DI water is added to about 40 ml, 5 ml HNO₃ is added and one drop of KMnO₄ is added. The solution is diluted to the 50 ml mark using additional DI. One ml potassium thiocyanate solution is added and the colorimetric tubes are shaken to mix. The tubes were allowed to stand for about 20 minutes and the absorbance measured was measure. The Fe(III) content of our filtrate can be calculated by the following formula:

$$ironIII ( filtrate ) = ( \frac{Abs - 0.06}{2.514} ) \times ( \frac{100 \times 1000}{40 \times 2 \times 1000} ) ( g ) \qquad ( 13 )$$

The ratio of the Fe(III) content in the filtrate to the iron content in the initial FeOOH yields the conversion factor.

### Particle Size Analysis

Particle size has been measured with a set of U.S.A. Standard Testing Sieves commercialized by W. S. Tyler. The particle sizes were distributed between 0.0331 inch and 0.078 inch.

### BET Surface Area

The BET surface area and mesoporous size distribution of the FeOOH particles were measured by nitrogen adsorption and desorption analysis (Micrometritics, ASAP 2010).

Pore size greatly affects the active surface area of the particles. Controlling the pore structure of the FeOOH+KOH complex will allow the needed size and amount of potassium ions to enter the FeOOH pores and allow the desired high amount of ozone to enter and leave the FeOOH+KOH complex pores. To that end, the FeOOH samples and FeOOH+KOH complex samples were analyzed at with a Micrometrics ASAP 2010 chemisorptions controller to provide the samples' surface area in m²/g, absorption cumulative pore volume of pores in cm³/g, average pore diameter in A and many others results.

### Results and Discussion

### Characteristics of FeOOH

The surface area of FeOOH is 185.7 m²/g, the absorption cumulative pore volume of pore of 0.087 cm³/g and an average pore diameter of 2.5 nm.

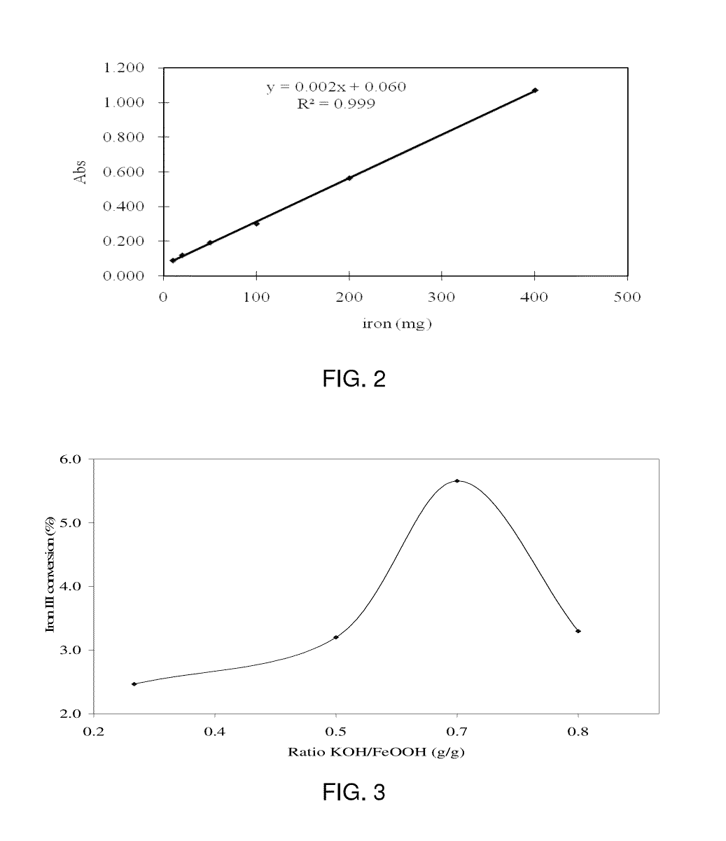

The standard curve of Fe(III) analysis which with R² of 0.999 is shown in FIG. 2. The Fe(III) content of FeOOH were tested three time using the method described above and yielded 42.1% on average. This value was used to calculate the conversion efficiency for oxidation of Fe(III) into Fe(VI).

### KOH Adsorption by the FeOOH on the Conversion of Ferrate

The concentration of KOH in the reaction is a crucial factor for the ferrate preparation. From an economical and technological stand point, the study of KOH dose influence on ion potassium adsorption by limonite at constant KOH solution concentration was important. Thus, various proportions of KOH:FeOOH were used to prepare the ferrate in this study. The complex FeOOH+KOH was dried at around 70° C. for two hours and reacted with ozone at a temperature of 30° C. for 40 minutes. The mass flow rate of ozone was 21.41 g/h. The results are shown in FIG. 3.

It can be seen that 0.65:1 was the KOH:FeOOH proportion that gives the best production of Ferrate VI. A study made by Abdus Salam in 2005 shows that although there was an increasing sorbent adsorption as the sorbent increases, the percentage of sorbent per FeOOH decreases at a certain dose of KOH. Accordingly, if the ratio KOH/FeOOH becomes largely greater than 0.65/1, there is an increase of ion potassium that is not adsorbed and reduces the reaction surface by covering.

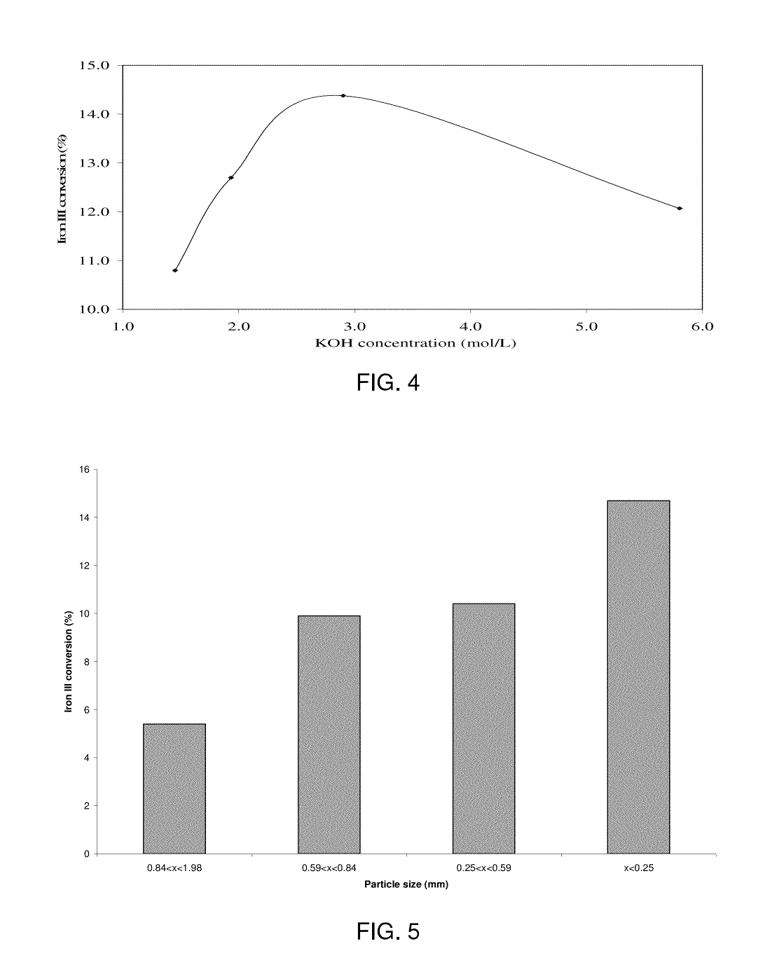

The effect of the KOH solution concentration on the ferrate production was also analyzed. The KOH:FeOOH ratio was fixed at 0.65:1. The FIG. 4 showed the results.

So, using a KOH solution of concentration around 1.5-6 mol/L, high conversion (>10%) could be produced. Meanwhile, the highest conversion 14.37% with a KOH solution of concentration 2.6 mol/L was found. This result fits into the Langmuir adsorption isotherm equation which forecasts an increase of the adsorption as the initial adsorbate concentration increases. The conversion decrease after 2.6 mol/L was caused by the excess of humidity in the complex FeOOH+K⁺. The adsorption of ion potassium by limonite can be represented as:

FeOOH+KOH⇄K.FeOOH (14).

The surface reaction here is a single-site mechanism in which only the site on which the reaction is adsorbed is participating in the reaction.

### Preferred Particle Size of FeOOH

FeOOH particle size was a concern to increase the reaction surface in the reactor and, accordingly, the conversion as function of four size ranges was analyzed. Using the same previous conditions and adopting the optimum KOH condition found which was 2.902 mol/L evaluated four different ranges of FeOOH size were analyzed. The result in FIG. 5 shows a significant increase of the conversion with the decrease in particle size.

With FeOOH particle size smaller than 0.0097 inch, 14.7% of the iron III was converted into iron VI, which was the highest conversion observed. It appears very clear that smaller particles had larger surface for reaction and by consequence higher conversion was achieved. The BET analysis has shown that in the case of the optimum sample from the adsorption step, the adsorption cumulative pore volume of pores before adsorption was 0.087 cm3/g and 0.025 cm3/g after adsorption. This represents a 78.75% of volume pore filled by potassium ions. Also, the adsorption cumulative surface area of pores before adsorption was 58.88 m2/g while 1.05 m2/g after adsorption. This indicates that during adsorption, a multilayer has formed wherein potassium ions were deposited on those already adsorbed. This problem is not addressed by the Langmuir theory but by the BET isotherm.

### Effect of the Particle Humidity on the Conversion

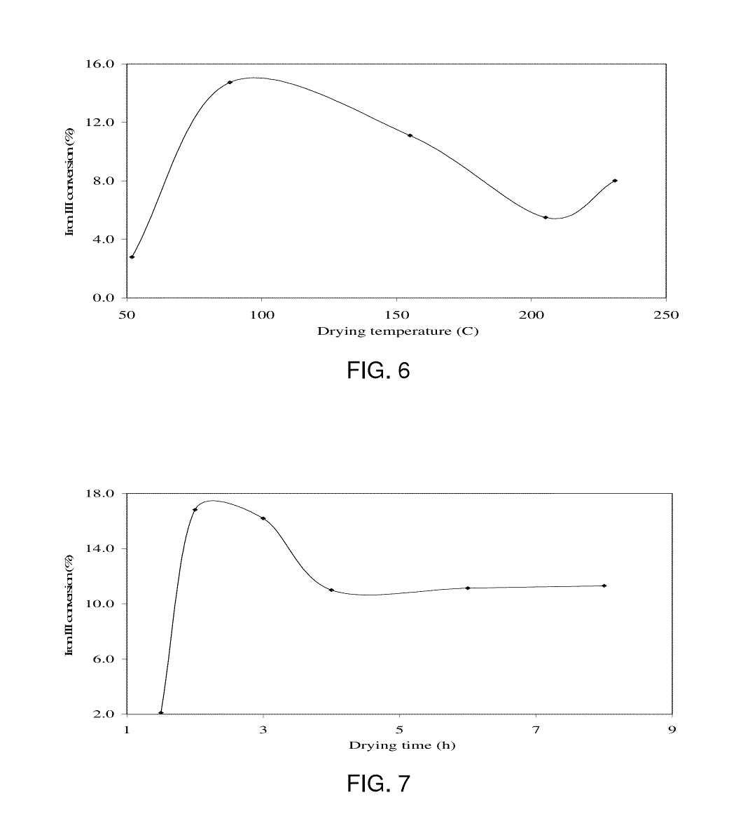

The humidity content in the complex FeOOH+KOH was a very important factor since it was observed that no ferrate could be produced if the sample was not dried enough. Also, a certain temperature might affect the structure of the FeOOH. Several samples were prepared in the optimum conditions already found which are KOH:FeOOH proportion 0.65:1, KOH concentration 2.905 mol/L and particle size range lower than 0.0097 inch. The complex of KOH:FeOOH was dried at different temperatures for two hours. The ferrate preparation was conducted under conditions wherein the ozone oxidation was performed for 40 minutes at 30° C. and the mass flow rate of ozone was 21.41 g/h. FIG. 6 presents the ferrate conversion obtained at different oven temperatures. The highest conversion was observed at the drying temperature of 88.2° C. Keeping the oven temperature at around 80° C. to 90° C. for better conversion is recommended. In fact, limonite decomposition has been identified for the condition 2α-FeOOH→α-Fe₂O₃+H₂O at 1-8 GPa and 100-400° C. (Gleason, Jeanloz and Kunz, 2008). At 1 bar the FeOOH loses its OH part when under a temperature of 100° C. and higher.

The experiments were performed where the boiling point of water is 92° C. due to the elevation (2183m), so it is important to dry at a temperature under that 92° C. to preserve the limonite structure.

The effect of drying time on the ferrate conversion at 88° C. was also examined and the results were shown in FIG. 7. There was no ferrate produced if the sample had not been dried at least 1.5 hour

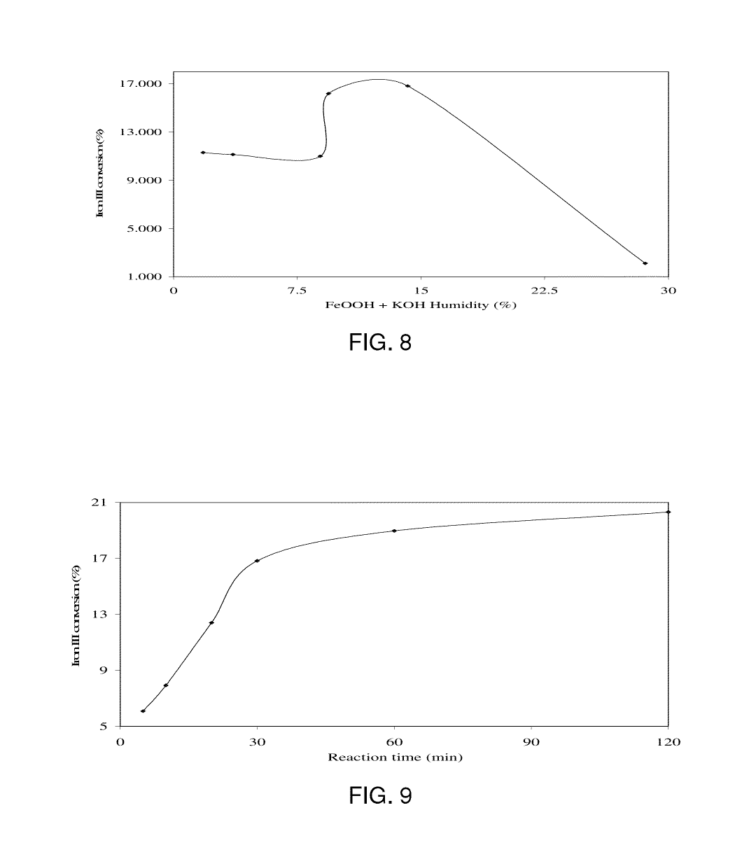

It can be seen that drying the sample for 2 hours or longer could produce a conversion of more than 10%. Higher conversions were obtained when the drying time was from two to three hours. Experimentally, by comparing the dried weight samples and their weight immediately out of the oven, the moisture corresponding to the drying duration at drying temperature of 88° C. could be evaluated. FIG. 8 expresses the moisture of complex FeOOH:KOH on the ferrate conversion.

Moisture and temperature variations could trigger condensation which drastically reduced the conversion. In fact, in presence of moisture the ozone will disintegrate into OH-radical to produce a parallel oxidation reaction. This second reaction is more likely to be dominant because hydroxyradical has a higher oxidation potential (2.86 V) than ozone (2.07 V).

### Effect of the Reaction Time on the Ferrate Conversion

The effect of ozone oxidation time on the ferrate conversion was evaluated. The reaction temperature was set at 30° C. and the mass flow rate of ozone was 21.41 g/h. The result in FIG. 9 showed that 8% of Iron III was converted to Iron VI in the first 10 minutes of the reaction. The conversion was higher with the time prolonged, and 17% conversion was gotten when the reaction time was about 38 mins. At the reaction of 120 min, nearly 20% conversion was found.

While it seems that the conversion could be improved by extending the reaction time, the difference between two hours of reaction and one hour is only a 3% increase of the conversion. In fact, at a certain point of the reaction, the non oxidized surface accessible by the ozone has decreased with the conversion rate.

### Effect of Reaction Temperature on the Ferrate Conversion

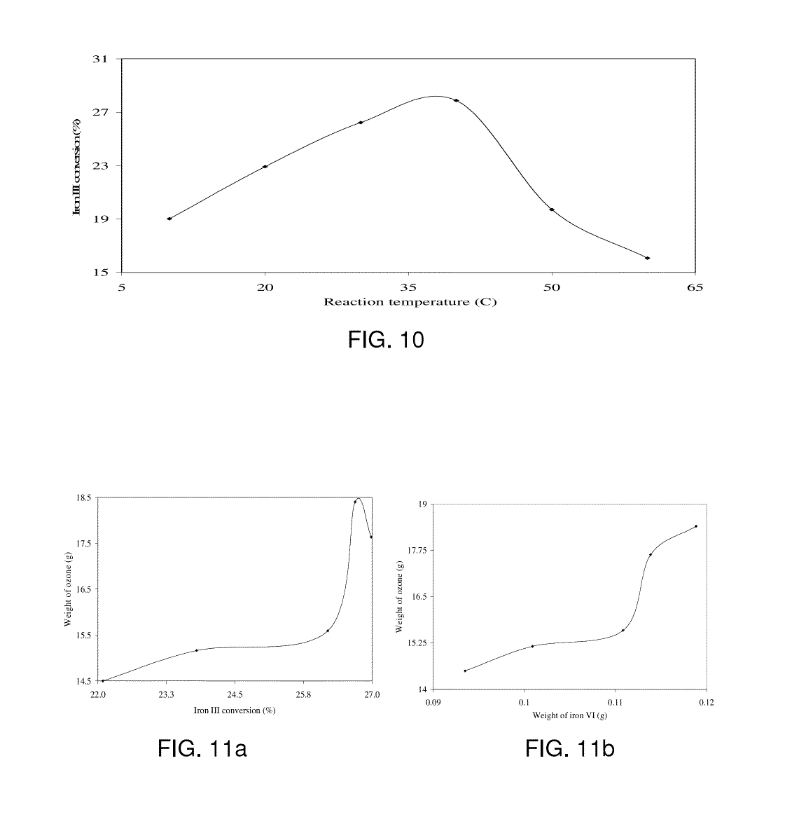

Controlling the reaction temperature was also very important and accordingly experiments were conducted at different temperatures using a reaction time was 2 hours and a mass flow rate of ozone of 21.41 g/h. From FIG. 10 it can be seen that the maximum conversion close to 28% was achieved at the reaction temperature of 40° C. Too low of a temperature in the reactor is susceptible to cause condensation and result in a non-desirable reaction that will limit ferrate conversion. Excessive temperatures, on the other hand, are generally a bad condition for oxidation. The best temperature range for oxidation is in the range of 30° C. to 50° C.

### Material Balance Analysis

The accounting of mass entering and leaving the system was done for engineering and environmental purposes. The results can be used to redesign the reactor or analyze alternative processes to improve the surface contact between reactants. A better monitoring of the reactants limits or eliminates wastes for environmental and economical advantages.

One gram of iron hydroxide was used for every sample, and all of the preferred conditions for preparation determined from the above experiments were used. The ozone and humidity were monitored using the gas flow regulated by the pressure and the flow rate. Table 1 sets out the values of the settings before the reactions.

TABLE 1
Parameter setting before the reaction

| | | | values for |
|---|---|---|---|
| | values for | values for | sample 31, 33, |
| Parameters | sample 21 | sample 22 | and 42 |
| Generator pressure (Psi) | 9.5 | 6.5 | 11 |
| Generator flow rate (L/min) | 3 | 1.8 | 2 |
| Ozone control (%) | 100 | 100 | 100 |
| Analyzer pressure (psia) | 11.35 | 14.62 | 14.62 |
| Analyzer flow rate (L/min) | 0.8 | 0.8 | 0.8 |
| Concentration of ozone (W %) | 3.753 | 4.815 | 4.672 |
| Weight of ozone entering the | 25.659 | 32.920 | 31.942 |
| reactor (g) | | | |
| Dry temperature ° C. | 24.5 | 24 | 24 |
| Wet temperature ° C. | 22.5 | 23.5 | 23 |
| Relative humidity (%) | 87 | 92 | 96 |
| Absolute humidity | 0.0168 | 0.0175 | 0.0184 |

### Ozone Monitoring

The ozone concentration of the gas stream entering the reaction and the ozone concentration of the gas leaving the reaction were monitored. During the reaction, the ozone concentration of exiting gas was being recorded every 20 minutes for samples 21 and 22 and every five minutes for samples 31, 33 and 42. The reactor was shaken to increase the surface contact between the particle and the gas inside the reactor. The weight of ozone participating in the reaction was determined.

### Ozone Consumption Analysis

The ozone consumption was approximately linear over the two hours of reaction for all samples at between about 0.13 g/min and 1.5 g/min.

The correlation between the ozone consumption and the conversion of iron was also analyzed. The results In FIGS. 11a and 11b show that the more ozone consumed, the more iron III is converted into iron VI. The weight increases with the conversion except in the case with the last sample 42, but supports the conclusion that ozone consumption increases the conversion factor.

### Ozone Recycling

The calculation of the average percentage of the ozone consumed every five minutes during the reaction of sample 31, 33 and 42 taught that an average 48% of the ozone with was consumed with consumption dropping as low as 22%, resulting in a loss on average of 16 g of ozone to produce only 0.12 g of Iron VI. It is proposed that one or more reactors be added in series to reduce our ozone emission while increasing the oxidation of iron III.

### Humidity Monitoring

Humidity monitoring consisted in determining the direction of the moisture exchange, the weight of water exchanged and an attempt to model the water consumption. For this analysis, the humidity content in the gas stream was measured before the reaction and in the gas stream leaving the reaction comparing the gas stream dry and wet temperatures on a Psychrometric chart. During the reaction, the humidity was recorded every 40 minutes and the difference in the weight of water contained in the gas stream was calculated. The results clearly showed that the gas stream was gaining water from the reaction. An average of 0.25 g of water was produced by the reaction.

### Mass Balance

In a typical reaction, 1 g of FeOOH was reacted with 4 ml of H₂O and 0.65 g of KOH. The reaction product was dried, losing 1.26 g of H₂O. The ozone generator produced 652.81 g of O₂, 30.88 g of O₃ and 4.08 g of H₂O. The reactor produced 0.42 g of Fe(III), 0.12 g Fe(IV), 0.46 g of other components and 0.27 g of H₂O. The effluent was comprised of 668.575 g of O₂, 15.116 g of O₃, and 4.368 g of H₂O.

### SUMMARY

A novel approach to generate stable solid multifunctional Fe⁶⁺—Fe³⁺ agent has been developed. This method is original, safe and cleaner than the existing methods. The preferred conditions for the Fe³⁺→Fe⁶⁺ conversion have been determined to be a FeOOH particle size <0.24638 mm, KOH/FeOOH0.65, a KOH solution concentration of 2.6 mol/L, a drying temperature of 88.2° C., a drying time of 2 hours, a reaction time of 120 minutes, a mass flow rate of ozone of 21.41 g/h and a reaction temperature of 40° C. The best conversion obtained was about 27%. Our ozone consumption study has shown an increase of the iron III conversion into iron VI when the ozone consumption was increasing.

### Example 2

### Hydrocarbon and Tetracycline Oxidation into water by Fe⁶⁺—Fe³⁺ Agent

Fe⁶⁺ Oxidation of Oil into Water

The clean up difficulties and low efficiency during the oil spill in the Gulf of Mexico (April, 2010) have revealed an urgent need to face the realities of challenges related to offshore petroleum operations which are crucial considering the fast growth of the world demand for energy and to address the problem of oil elimination from water. Iron ferrate (FeO₄²⁻) has been found to be a powerful oxidant in water treatment over a wide pH range. The oxidation results in a reduction of FeO into Fe³⁺ which is a coagulant. This agent has been proven effective in the degradation of various organic and inorganic pollutants such as alcohol, amino acids, and organic nitrogen compounds, endocrine disrupt chemical and many others. However, it had never been proved useful in hydrocarbon oxidation before, probably owing to inconvenience related to its instability in the liquid phase and time and difficulty in preparation. The stable Fe⁶⁺—Fe³⁺ agent prepared as described in Example 1 has been found to be highly effective at oxidizing crude oil in water by Fe⁶⁺ over a wide pH range. In pH 7 water pH it was possible to oxidize an equivalent of 0.23 g of oil with 1.1 g of Fe⁶⁺, resulting in oxidation of 97.6% of the initial oil.

### Materials and Methods

The crude oil and sulfuric acid used in this study were of commercial origin. The crude oil was type Minnelusa of viscosity 8 cp, from the Raven Creek Field in the Powder River Basin of Wymoing. The most prevalent hydrocarbon groups were C₁₀ to C₂₅ straight-chain alkanes. The sulfuric acid was purchased from Fisher Scientific and of concentration 98.07%. Meanwhile the Fe⁶⁺—Fe³⁺ powder agent was prepared as described in Example 1. The powder was roughly composed of 11.3% Fe⁶⁺ and 30.6% Fe³⁺.

### Experimental Procedures

### Water Samples Preparations

The experiment consisted of preparing water samples containing a selected quantity of crude oil to which was added the Fe⁶⁺—Fe³⁺ powder agent and the mixture stirred. Two experiment sets were conducted to determine the oxidation effectiveness as a function of the oil/Fe⁶⁺—Fe³⁺ powder proportion first and as a function of the water pH.

For the first experiment, 0.3 L of distilled water was poured in each of four 1 L beakers. The water temperatures in the beakers was 21.5° C. and the pH=7. In each of the beakers 0.5 ml of crude oil was added and the beakers were labeled from 51 to S4. Introduced in the beakers 51, S2 and S3 were Fe⁶⁺—Fe³⁺ powders made from 11 g, 8 g and 2 g of FeOOH, respectively. No Fe⁶⁺—Fe³⁺ powder was added to beaker S4. We stirred the 51, S2 and S3 samples until the purple color in the water disappears. The purple color was gone respectively 72 hours for S2 and 24 hours for S3. At 120 hours, we still had the purple color in 51 with very little trace of oil in the beaker, so we stopped the stirring and took the 4 samples for analysis.

In the second experiment, four samples were created each using 60 ml of water, 0.1 ml of oil, and Fe⁶⁺—Fe³⁺ powder made from 2.2 g of FeOOH. The pH of the water used for the four samples was 4, 5, 6 and 7 for samples 1-4, respectively. After stirring, the samples were allowed to stand at least 45 minutes so that the Iron II and III present in the samples could settle down to the bottom of the beakers.

### TOC Analysis

The Total Organic Carbon of samples from the first experiment has been analyzed by the Wyoming Analytical Laboratory in Laramie, Wyo. The samples from the second experiment using a TOC analyzer from Shimadzu, Model TOC-VCSN. Both analyzers use EPA method 1664 hexane extractable oil and grease. The detection levels are 2 mg/l over C₈-plus range and the results were lump parameter.

### Experimental Results and Discussions

### Oxidation at Various Oil/Fe⁶⁺—Fe³⁺ Powder Proportion

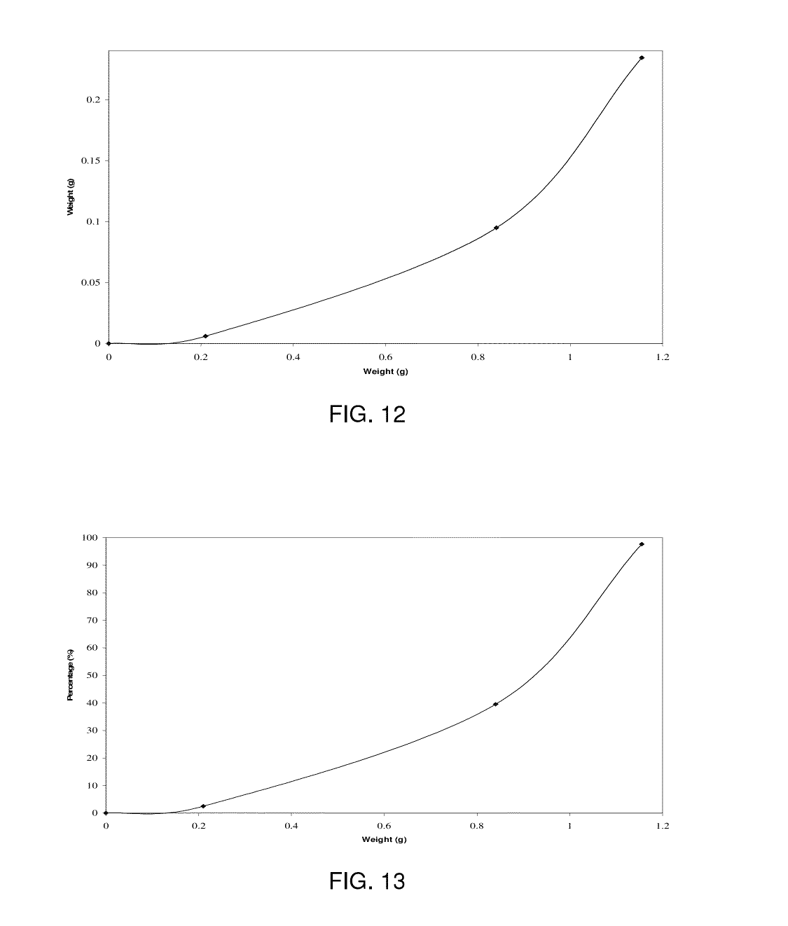

Using the results, how much iron VI was introduced in each solution and how much organic carbons were oxidized was calculated and are plotted in FIGS. 12 and 13.

While it is recognized that an overdose of Iron VI will improve the oxidation of organic compounds present in the water for samples of same pH, most of the 0.5 ml of crude oil was oxidized by 1.15 g of Fe⁶⁺.

### Effect of Water pH in the Oxidation Effectiveness

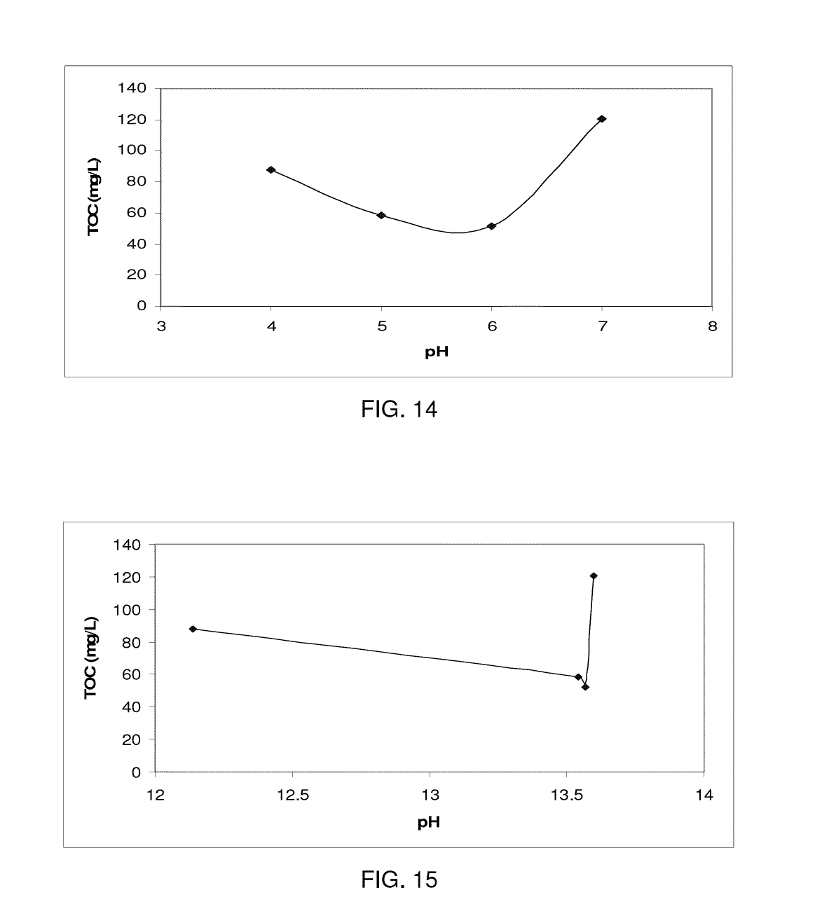

It took approximately 100 hours for the last reaction to be done. As expected, the reaction of the 7 pH sample ended last. These samples were analyzed using the TOC-VSCN analyzer. There is a direct correlation between the resulting TOC after oxidation and the initial water pH. The pH of the sample after oxidation was also measured. The results are shown in FIGS. 14 and 15. It can be seen that water with pH range of 5-6 is a favorable environment for the oxidation. It should be noted that the pH increases considerably during the oxidation process due to the presence of potassium in the prepared Fe⁶⁺—Fe³⁺ powder agents.

### Tetracycline Decomposition

### Materials and Methods

Tetracycline, ferrate, formic acid and ammonium hydroxide were involved in this experiment process. The ferrate (K2FeO4) used to decompose the tetracycline was made as disclosed in Example 1 by oxidizing a mixture of FeOOH+KOH complex. About 20% of Fe(III) is converted to Fe(VI). The formic acid used in this research was bought from J. T. Baker and its concentration is 88%. The ammonium hydroxide was provided by Fisher Scientific, and its normality is 14.8.

A 1 L tetracycline (20 mg/L) and 1 L ferrate solution (40 mg/L) were prepared. Then different volumes of the ferrate solution (40 ml/L) were used for degradation of 50 ml of tetracycline (20 mg/L). The pH of the post-degradation solutions was measured.

After 16 hours of reaction, formic acid was used to reduce the pH of the solutions to 2. Then the pH was elevated to 4.5-5.5 using ammonium hydroxides. At the end, the samples were filtered using a pipette-filter assembly.

Four samples were prepared for analysis: Sample tagged “initial” contains only tetracycline (20 mg/L); Sample tagged “1” is the solution resulting from the reaction of 50 ml tetracycline (20 mg/L) and 50 ml of ferrate (40 mg/L), wherein the post-reaction (degradation) pH=7.5; Sample tagged “2” is the solution resulting from the reaction of 50 ml tetracycline (20 mg/L) and 35 ml of ferrate (40 mg/L), wherein the post-reaction (degradation) pH=7; and Sample tagged “3” is the solution resulting from the reaction of 50 ml tetracycline (20 mg/L) and 20 ml of ferrate (40 mg/L), wherein the post-reaction (degradation) pH=6.5.

### LC/MRM Analysis

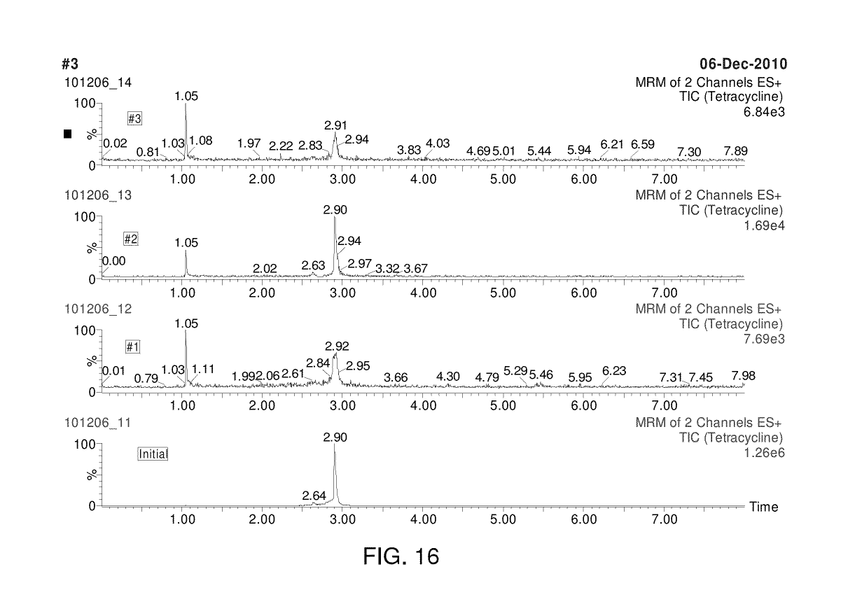

The analysis method was a combination of the liquid chromatography and magnetic resonance microscopy. The results are shown in FIG. 16 wherein the data is presented, from top to bottom, as Sample 3, Sample 2, Sample 1, and Initial. Note the scale in the upper left corner of each chromatogram. The bottom window is 10̂6 counts high, the upper three are 10̂3. If they were plotted on the same scale, the 3 treated samples would not show above baseline. It is clear that the tetracycline was destroyed with even the lowest Fe⁺ treatment.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

### REFERENCES

1) Jiang, J. Q., and Lloyd, B. (2002). “Progress in the development and use of ferrate (VI) salt as an oxidant and coagulant for water and wastewater treatment.” Water Research. 36(6), 1397-1408.
2) Wood R. H. (1958). “The heat, free energy, and entropy of the ferrate (VI) ion.” J. Amer. Chem. Soc., 80, 2038-2041.
3) Graham N., Jiang C. C., and Li X. Z. (2004). “The influence of pH on the degradation of phenol and chlorophenols by potassium ferrate.” Chemosphere, 56, 949-956.
4) Sharma, V. K. (2010). “Oxidation of Nitrogen-Containing Pollutants by Innovative Ferrate (VI) Technology: A Review.” J. Environ. Sci. Health A., 45, 645-667.
5) Williams et al. (1974). “Preparation and Alcohol Oxidation Studies of the Ferrate (VI) Ion, FeO₄⁻².” Inorganica Chimica Acta., 8, 177-183.
6) Rush, J. D., and Bielski, B. H. J. (1995). “The oxidation of amino acid by ferrate (V). A pre-mix pulse radiolysis study.” Free Radical Res., 22, 571-579.
7) Noorhasan, N., Patel, B. and Sharma, V. K. (2010). “Ferrate (VI) oxidation of glycine and glycylglycine: Kinetics and products.” Water Research, 44(3), 927-935.
8) Li, C. and Li, X. Z. (2007). “Degradation of endocrine disrupting chemicals in aqueous solution by interaction of photocatalytic oxidation and ferrate (VI) oxidation.” Water Science & Technology, 55 (1-2), 217-223.
9) Virender K. Sharma, Santosh K. Mishra, and Ajay K. Ray. (2006). “Kinetic assessment of the potassium ferrate (VI) oxidation of antibacterial drug sulfamethoxazole.” Chemosphere, 62, 128-134.
10) Maohong, F., Robert, C. Brown, and Chin-Pao Huang. (2002). “Preliminary studies of the oxidation of arsenic(III) by potassium ferrate.” International Journal of Environment and Pollution, 18(1).
11) Virender K. Sharma, Futaba Kazama, Hu Jiangyong and Ajay K. Ray. (2005). “Ferrates (iron(VI) and iron(V)): Environmentally friendly oxidants and disinfectants.” Journal of Water and Health, 21(07), 1-15.
12) Schreyer, J. M., Thompson, G. W., and Ockerman, T. (1950). “Ferrate oxidimetry:oxidation of arsenite with potassium ferrate (VI).” Anal. Chem., 22, 691-692.
13) Thompson, G. W., Ockerman, L. T. and Schreyer, J. M. (1951). “Preparation and Purification of Potassium Ferrate (VI)”. J. Am. Chem. Soc., 73, 1379-1381.
14) Schreyer, J. M., Thompson, G. W., and Ockerman, L. T. (1953). “Potassium Ferrate, Inorganic Synthesis”., IV, 164-169.
15) White, D. A., and Franklin, G. S. (1998). “A Preliminary Investigation into the Use of Sodium Ferrate in Water Treatment.” Environmental Technology., 19 (11), 1157-1161.
16) Bouzek, K., and Rousar, I. (1993). “Current efficiency during anodic dissolution of iron to ferrate (vi) in concentrated alkali hydroxide solutions.” 1317-1322.
17) Licht, S., Naschitz, V., Ghosh, S, and Lin, L. (2001). “SrFeO4 synthesis, Fe(VI) characterization and the strontium super-iron battery.” Electrochemistry Communications., 3, 340-345.
18) Lapicque, F. and Valentin, G. (2002). “Direct electrochemical preparation of solid potassium ferrate.” Electrochemistry Commuinications, 4, 764-766.
19) Licht, S. (2002). “Direct electrochemical preparation of solid FE(VI) ferrate, and super-iron battery components.” Electrochemistry Communications., 4, 933-937.
20) He, W., Wang, J., Yang, C. and Zhang, J. 2006. “The rapid electrochemical preparation of dissolved ferrate (VI): Effects of various operating parameters.” Electrochemica Acta, 51, 1967-1973.
21) Stahl, G. E. (1715). “Opusculum Chimico-physico-Medicum; Halae-Magdeburgiae.” 742.
22) Karl, F. and Schoch, Jr. (1997). “Method for preparation of ferrite powders at room temperature.” U.S. Pat. No. 5,662,879.
23) Bielski, B. H. J. and Thomas, M. J. (1987). “Studies of hypervalent iron in aqueous solutions. 1. Radiation induced reduction of iron(VI) to iron(V) by CO.” J. Am. Chem. Soc., 109, 7761-7764.
24) T. Logager, J. Holcman, K. Sehested and T. Pedersen. (1992). “Oxidation of ferrous ions by ozone in acidic solutions.” Inorg. Chem., 31, 3523.
25) Perfiliev, Y. D., Benko, E. M., Pankratov, D. A., Sharma, V. K. and Dedushenko, S. D. (2007). “Formation of Iron(VI) in Ozonalysis of Iron(III) in Alkaline Solution.” Inorg. Chim. Acta., 360, 2789-2791.
26) Abdus-Salam, N. and Adekola, F. A. (2005). “The influence of pH and adsorbent concentration on adsorption of lead and zinc on a natural goethite.” African Journal of Science and Technology (AJST), Science and Engineering Series, 6(2), 55-66.
27) Gleason, A. E., Jeanloz, R., and Kunz, M. (2008). “Pressure-temperature stability studies of FeOOH using X-ray diffraction.” American Mineralogist. November-December, 93 (11-12), 1882-1885.
28) Andelin et al. (1991). “Bioremediation for Marines Oil Spills.” Science Information and Natural Ressources Division.
29) Ghosh et al. (1991). Science 285, 1039.
30) Hen et al. “Materials and Methods for Wound Treatmtment.” US Patent Application Publication No. 2009/0252799.
31) Arancibia-Avila et al. (2000). “Effects of pH on cell morphology and carbonic anhydrase activity and localization in bloom-forming Mougeotia (Chlorophyta, Charophyceae).” Canadian Journal of Botany, 78 1206-1214.
32) Virender, K. and Sharma. (2010). “Oxidation of nitrogen-containing pollutants by novel ferrate (VI) technology: A review.” Journal of Environmental Science and Health, Part A, 45(6), 645-667.
33) Fan et al. (2002). “Preliminary studies of the oxidation of arsenic (III) by potassium ferrate.” International Journal of Environment and Pollution (IJEP), 18(1).
34) Green, J. R. (2001). “Potassium Ferrate” Encyclopedia of Reagents for Organic Synthesis.

We claim:

1. A method of making solid Fe(VI), comprising the steps of:
(a) adsorbing an alkali metal hydroxide onto Fe(III) oxide-hydroxide to produce a Fe(III) composition; and
(b) exposing the Fe(III) composition to ozone to convert the Fe(III) to Fe(IV).

2. A method of claim 1, wherein the Fe(III) oxide-hydroxide comprise particles in the range of between 0.01 inches and 0.2 inches.

3. A method of claim 2, wherein the Fe(III) oxide-hydroxide comprise particles in the range of between 0.03 inches and 0.8 inches.

4. A method of claim 2, wherein the BET surface area of the particles is greater than 10 m²/g and preferably greater than 100 m²/g.

5. A method of claim 2, wherein the Fe(III) oxide-hydroxide comprise particles of limonite.

6. A method of claim 1, wherein the Fe(III) composition is dried prior to exposure to ozone.

7. A method of claim 1, wherein the exposure to ozone is at an elevated temperature.

8. A method of claim 7, wherein the temperature is between 20° C. and 100° C., standard pressure.

9. A method of claim 1, wherein the alkali metal is selected from the group consisting of sodium and potassium.

10. A method of claim 9, wherein the alkali metal is potassium and ratio of KOH to Fe(III) oxide-hydroxide is between 0.4 and 0.8 and preferably between 0.6 and 0.75.

11. A method of claim 9, wherein the alkali metal is potassium and the concentration of the KOH solution is between 1.5 and 6 mol/L and preferably between 2.0 and 4.0 mol/L.

12. A method of making solid K₂FeO₄, comprising the steps of:
(a) adding a source of FeOOH to an aqueous solution of potassium hydroxide to form a reaction mixture;
(b) drying the reaction mixture to form a dry Fe(III) composition;
(c) adding the Fe(III) composition mixture to a reactor; and
(d) passing ozone over the Fe(III) composition in the reactor to convert the Fe(III) to Fe(IV).

13. A method of claim 10, wherein the ratio of KOH to FeOOH is between 0.4 and 0.8 and preferably between 0.6 and 0.75.

14. A method of claim 10, wherein the concentration of the KOH solution is between 1.5 and 6 mol/L and preferably between 2.0 and 4.0 mol/L.

15. A method for oxidizing contaminants in water, comprising adding the solid Fe(IV) of claim 1.

16. A method of claim 15, wherein the contaminants comprise hydrocarbons.
